(19) United States
(12) Patent Application Publication
(10) Pub. No.: US 2018/0089842 A1
(43) Pub. Date: Mar. 29, 2018

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Shogo Mizuno, Tokyo (JP)

(21) Appl. No.: 15/711,913

(22) Filed: Sep. 21, 2017

(30) Foreign Application Priority Data
Sep. 27, 2016 (JP) 2016-188762

(51) Int. Cl. G06T 7/292; G06T 19/00

(52) U.S. Cl. CPC G06T 7/292; G06T 19/003; G06T 2207/10016; G06T 19/006

(57) ABSTRACT

An image processing apparatus accepts a designated virtual viewpoint, and acquires a result of specific-object detection processing performed for a virtual viewpoint image corresponding to the accepted virtual viewpoint. The image processing apparatus then executes addition processing for displaying, together with the virtual viewpoint image corresponding to the designated virtual viewpoint, information about a specific object detected from another viewpoint image corresponding to another viewpoint different from the designated virtual viewpoint. The addition processing is executed according to the result of the specific-object detection processing.

### BACKGROUND

### Field

The present disclosure relates to an image processing method for processing images captured by a plurality of cameras.

### Description of the Related Art

In recent years, a technology for generating a virtual viewpoint image has been receiving attention. According to this technology, image capturing is synchronously performed at multiple viewpoints by cameras installed at different positions, and viewpoint images are obtained by this image capturing. Using the obtained viewpoint images, not only the images captured at the positions where the cameras are installed, but also a virtual viewpoint image from an arbitrary viewpoint, are generated.

The generation of the virtual viewpoint image based on the viewpoint images can be implemented as follows. The images captured by the cameras are collected in an image processing apparatus such as a server, and then processing such as rendering based on a virtual viewpoint is performed in this image processing apparatus.

For example, content with high realistic sensation can be provided for a soccer or basketball game, according to a service using virtual viewpoint image technology.

Japanese Patent Application Laid-Open No. 2008-15756 discusses a technology for generating an arbitrary virtual viewpoint image, by using images of an object that are captured by cameras disposed to surround the object.

However, according to such a conventional technology, it is conceivable that operability related to setting of a virtual viewpoint may decrease.

For example, in a case where a user performs an operation for moving a virtual viewpoint while viewing a virtual viewpoint image, an object to be displayed may go out of the range of the virtual viewpoint image due to movement of the object or movement of the virtual viewpoint. In such a case, the user may become confused about in which direction the virtual viewpoint is to be moved in order to view the desired object.

To be more specific, assume that a virtual viewpoint image is generated based on images captured by cameras disposed to surround a soccer field. In such a case, depending on movement of a player playing a game and movement of a virtual viewpoint, a virtual viewpoint may be generated from which no object such as a player is viewable. When a user views a virtual viewpoint image in which no object such as a player appears, the user may be uncertain about in which direction to move the virtual viewpoint to view the desired object. Therefore, the user may look for the object by moving the virtual viewpoint in various directions to place the object within the virtual viewpoint. This is complicated operation. Moreover, moving the virtual viewpoint in various directions impairs the quality of a video's content.

### SUMMARY

According to various embodiments of the present disclosure, an image processing apparatus includes an accepting unit configured to accept a virtual viewpoint designated for a virtual viewpoint image to be generated based on images captured by each of a plurality of cameras for capturing an object from a plurality of different directions, an acquisition unit configured to acquire a result of specific-object detection processing performed for a virtual viewpoint image corresponding to the virtual viewpoint accepted by the accepting unit, and an addition unit configured to execute addition processing for displaying, together with the virtual viewpoint image corresponding to the virtual viewpoint accepted by the accepting unit, information about a specific object detected from another viewpoint image corresponding to another viewpoint different from the virtual viewpoint accepted by the accepting unit, the addition processing being executed according to the result acquired by the acquisition unit, of the specific-object detection processing performed for the virtual viewpoint image.

Further features will become apparent from the following description of exemplary embodiments with reference to the attached drawings.

### BRIEF DESCRIPTION OF THE DRAWINGS

FIG. 1 is a diagram illustrating a configuration of an image processing system according to an exemplary embodiment.

FIG. 2 is a functional block diagram of an image generation apparatus according to an exemplary embodiment.

FIG. 3 is a flowchart illustrating operation of an image generation apparatus according to an exemplary embodiment.

FIG. 4 is a conceptual diagram illustrating a positional relationship between virtual viewpoints according to an exemplary embodiment.

FIG. 5 illustrates an example of a screen of a terminal apparatus according to an exemplary embodiment.

FIG. 6 is a functional block diagram of an image generation apparatus according to an exemplary embodiment.

FIG. 7 is a flowchart illustrating operation of an image generation apparatus according to an exemplary embodiment.

FIG. 8 is a conceptual diagram illustrating a positional relationship between virtual viewpoints according to an exemplary embodiment.

FIG. 9 illustrates an example of a screen of a terminal apparatus according to an exemplary embodiment.

FIG. 10 illustrates an example of an arrangement of imaging apparatuses according to an exemplary embodiment.

FIG. 11 illustrates an example of a hardware configuration of an apparatus according to an exemplary embodiment.

### DESCRIPTION OF THE EMBODIMENTS

A technology for improving operability related to setting of a virtual viewpoint will be described below with reference to some exemplary embodiments.

Exemplary embodiments of the present disclosure will be described below with reference to the drawings.

A first exemplary embodiment will be described. An example to be mainly described in the first exemplary embodiment is as follows. First, a virtual viewpoint is designated by user operation. Further, an object is detected from an image (other viewpoint image) corresponding to a viewpoint (other viewpoint) different from the designated virtual viewpoint, and information about the detected object is combined with a virtual viewpoint image corresponding to the virtual viewpoint. A resultant image is then displayed. In particular, in the present exemplary embodiment, there will be mainly described an example in which, when a specific object is not detected from a virtual viewpoint image based on user operations, processing for detecting the specific object is performed for generating another viewpoint image.

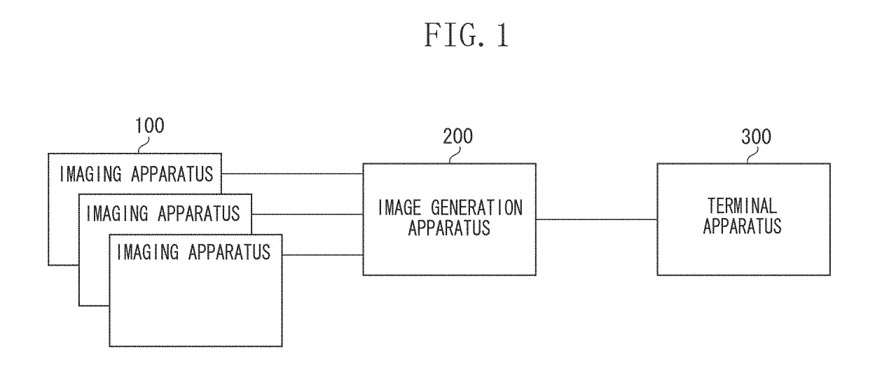

FIG. 1 is a connection diagram of an image processing system according to the first exemplary embodiment. An imaging apparatus 100 is each of cameras for capturing an image of an object from different directions. The imaging apparatuses 100 are disposed to surround a specific object in a sports stadium such as a soccer field, and each capture an image. However, a subject, to which the image processing system of the present exemplary embodiment is applicable, is not limited to a sports stadium. The image processing system of the present exemplary embodiment is applicable to, for example, concert halls, live venues, various exhibition venues, and entertainment facilities.

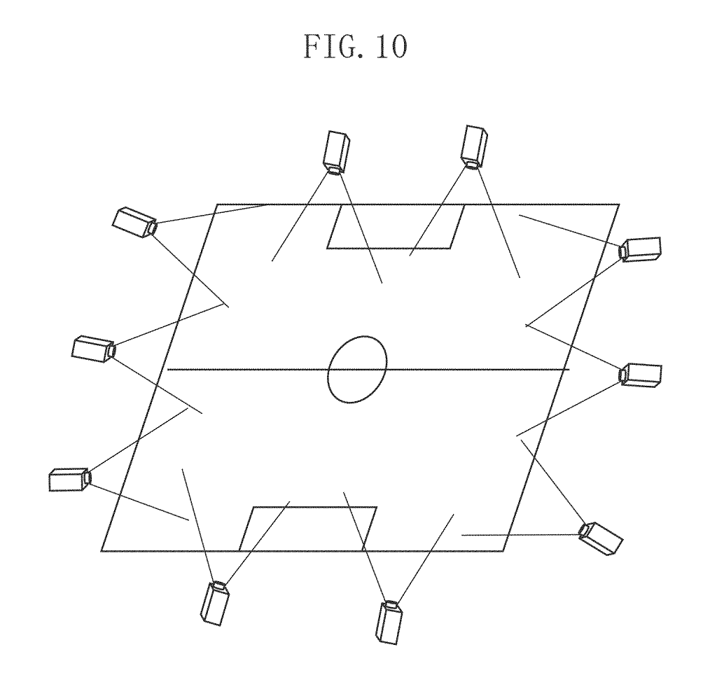

FIG. 10 is an example of an arrangement of the imaging apparatuses 100. The imaging apparatuses 100 are disposed so that a part or the whole of the sports stadium forms an imaging range.

The imaging apparatuses 100 are each, for example, a digital camera, and simultaneously perform image capturing based on a synchronization signal from an external synchronization apparatus (not illustrated). The image captured by each of the imaging apparatuses 100 is transmitted to an image generation apparatus 200, via a communication cable such as a local area network (LAN) cable. The communication cable is described using the LAN cable as an example, but may be a video transmission cable such as a DisplayPort cable and a High Definition Multimedia Interface (HDMI, registered trademark) cable. Images used in the present exemplary embodiment may each be an image captured using a still-image capturing function of the imaging apparatus 100, or an image captured using a moving-image capturing function of the imaging apparatus 100. The images will each be expressed below merely as an image or a captured image, without making a distinction in terms of whether the image is a still or moving image.

The image generation apparatus 200 accumulates images captured by the imaging apparatuses 100. Further, the image generation apparatus 200 generates a virtual viewpoint image corresponding to virtual viewpoint information transmitted from a terminal apparatus 300, by using the accumulated images. Here, the virtual viewpoint information at least includes three-dimensional position information and direction information. The three-dimensional position information indicates a position relative to a predetermined position such as the center of the sports stadium. The direction information indicates the direction of a view from this position.

The image generation apparatus 200 is, for example, a server apparatus. The image generation apparatus 200 is an example of an image processing apparatus including a database function and an image processing function. A database of the image generation apparatus 200 holds beforehand a captured image of the sports stadium in a state where no object is present, such as a state before start of a game. This captured image is held as a background image. The database also holds an image of an object (a specific object) such as a player playing a game, and this image is held as a foreground image. The foreground image can be generated, by detecting an object from an image captured by the imaging apparatus 100 and separating a region representing this object.

For example, image processing for object extraction, such as extraction of a difference between a captured image and a background image can be used as a specific method for separating the foreground image. Another separation method that can be used is, for example, a separation method using motion information about a captured image.

The foreground image (the image of the specific object) may be not only an image of the player playing the game, but also, for example, an image of another specific person (such as a substitute, a coach, or a referee). Further, the foreground image may be, for example, an image of an object having a predetermined image pattern, such as a ball or a goal. Furthermore, the foreground image may be an image of a person detected in a predetermined space region (e.g., a game field or a stage).

The virtual viewpoint image corresponding to the virtual viewpoint designated by the user operation is generated from the background image and the foreground image managed in the database. As a scheme for generating the virtual viewpoint image, for example, a model-based rendering (MBR) is used. The MBR is a scheme for generating a virtual viewpoint image by using a three-dimensional model generated based on a plurality of images obtained by imaging an object from a plurality of directions. Specifically, this is a technology for generating a view of a scene from a virtual viewpoint as an image, by utilizing a three-dimensional shape (a model) of a target scene. The three-dimensional shape is obtained by a three-dimensional shape reconstruction technique, such as volume intersection and multi-view stereo (MVS). A rendering technique other than the MBR may be used as the method for generating the virtual viewpoint image. The generated virtual viewpoint image is transmitted to the terminal apparatus 300, via a cable such as a LAN cable.

The terminal apparatus 300 accepts operation for designation of a virtual viewpoint, from a user. Further, the terminal apparatus 300 converts information representing the accepted operation into virtual viewpoint information, and transmits the virtual viewpoint information to the image generation apparatus 200 via the LAN cable. Further, the terminal apparatus 300 displays a virtual viewpoint image received from the image generation apparatus 200, on a display screen. Therefore, the user of the terminal apparatus 300 can perform operation for moving the virtual viewpoint while viewing the virtual viewpoint image corresponding to the virtual viewpoint designated by the user. The virtual viewpoint image corresponding to the virtual viewpoint designated at the terminal apparatus 300 may be distributed to the terminal apparatuses 300.

The terminal apparatus 300 is, for example, a personal computer (PC), a tablet, or a smartphone. The user can designate a virtual viewpoint by using any of a mouse, a keyboard, a 6-axis controller, and a touch panel included in the terminal apparatus 300.

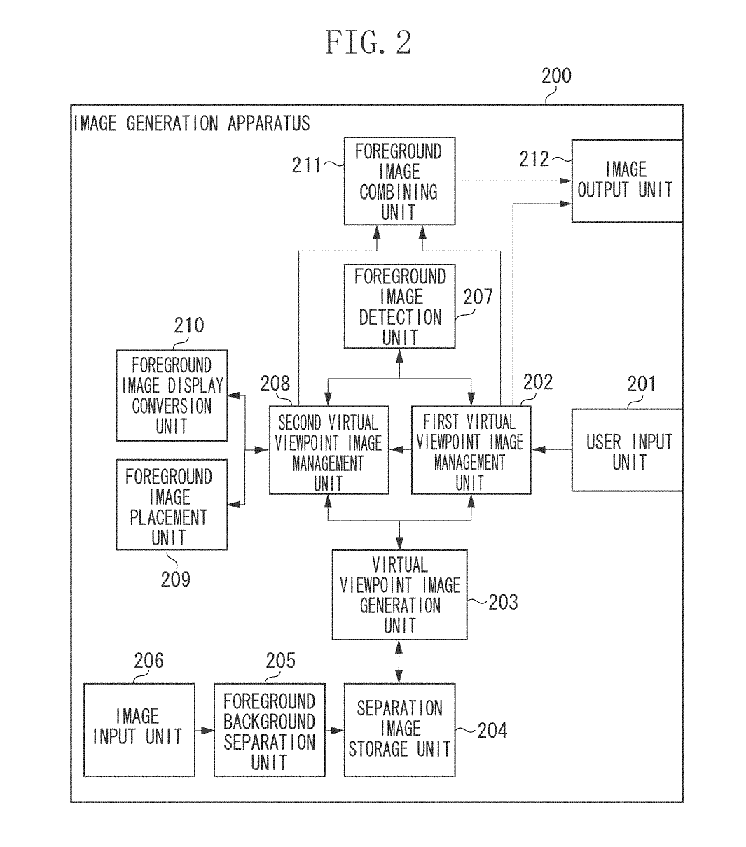

Next, a function of the image generation apparatus 200 will be described. FIG. 2 is a functional block diagram of the image generation apparatus 200 according to the first exemplary embodiment.

A user input unit 201 converts a transmission signal input from the terminal apparatus 300 via the LAN cable, into virtual viewpoint information. The user input unit 201 then outputs the virtual viewpoint information to a first virtual viewpoint image management unit 202.

The first virtual viewpoint image management unit 202 holds the virtual viewpoint information from the user input unit 201 as first virtual viewpoint information, and outputs the first virtual viewpoint information to a virtual viewpoint image generation unit 203. The first virtual viewpoint image management unit 202 also holds a virtual viewpoint image input from the virtual viewpoint image generation unit 203, as a first virtual viewpoint image. Further, the first virtual viewpoint image management unit 202 outputs the first virtual viewpoint information to a second virtual viewpoint image management unit 208 for generating a virtual viewpoint image corresponding to another viewpoint. Furthermore, to determine whether a foreground image corresponding to an object such as a player is included in the first virtual viewpoint image, the first virtual viewpoint image management unit 202 outputs the first virtual viewpoint image to a foreground image detection unit 207 and receives a detection processing result therefrom. Moreover, the first virtual viewpoint image management unit 202 outputs the first virtual viewpoint image to an image output unit 212.

An image input unit 206 converts a transmission signal input from the imaging apparatus 100 via the LAN cable, into captured-image data. The image input unit 206 then outputs the captured-image data to a foreground background separation unit 205.

The foreground background separation unit 205 outputs an image to a separation image storage unit 204, as a background image. The outputted image is one of the captured images input from the image input unit 206. This is an image, which is captured beforehand, of a scene of the sports stadium in a state that no object is present, such as a state before a game. In addition, the foreground background separation unit 205 detects an object such a player in an image captured during a game, and outputs an image representing the detected object to the separation image storage unit 204, as a foreground image.

The separation image storage unit 204 is a database that stores each of the foreground image and the background image input from the foreground background separation unit 205. The background image is an image captured by the imaging apparatus 100 in a state that no object (specific object) such as a player is present. The foreground image is an image of the specific object, generated based on data representing differences between an image captured by the imaging apparatus 100 and the background image. Further, in response to an acquisition instruction from the virtual viewpoint image generation unit 203, the separation image storage unit 204 outputs a background image and a foreground image designated by the acquisition instruction, to the virtual viewpoint image generation unit 203.

From the separation image storage unit 204, the virtual viewpoint image generation unit 203 acquires a foreground image and a background image corresponding to the first virtual viewpoint information input from the first virtual viewpoint image management unit 202. The virtual viewpoint image generation unit 203 then generates a virtual viewpoint image by combining the acquired foreground image and background image by performing image processing, and outputs the virtual viewpoint image to the first virtual viewpoint image management unit 202. Further, from the separation image storage unit 204, the virtual viewpoint image generation unit 203 acquires a foreground image and a background image corresponding to second virtual viewpoint information (other viewpoint) input from the second virtual viewpoint image management unit 208. The virtual viewpoint image generation unit 203 then generates a second virtual viewpoint image (other viewpoint image) by combining the acquired foreground image and background image by performing image processing, and outputs the generated second virtual viewpoint image to the second virtual viewpoint image management unit 208.

The foreground image detection unit 207 determines whether a foreground image is present in a virtual viewpoint image input from each of the first virtual viewpoint image management unit 202 and the second virtual viewpoint image management unit 208. The foreground image detection unit 207 compares an image captured beforehand in a state that no object is present (the background image), with a captured image, which is a target of the determination. If there is a difference equal to or greater than a predetermined value, the foreground image detection unit 207 determines that the object is present. The foreground image detection unit 207 outputs a result of determination as to whether a foreground image is present in the virtual viewpoint image input from the first virtual viewpoint image management unit 202, to the first virtual viewpoint image management unit 202. Further, the foreground image detection unit 207 outputs a result of detection processing as to whether a foreground image is detected from a virtual viewpoint image (other viewpoint image) input from the second virtual viewpoint image management unit 208, to the second virtual viewpoint image management unit 208.

The second virtual viewpoint image management unit 208 generates the second virtual viewpoint information by converting the first virtual viewpoint information input from the first virtual viewpoint image management unit 202. For example, the second virtual viewpoint image management unit 208 generates viewpoint information, which represents a viewpoint located behind a viewpoint represented by the first virtual viewpoint information, as the second virtual viewpoint information. In other words, the second virtual viewpoint information (other viewpoint) set by the second virtual viewpoint image management unit 208 is a virtual viewpoint having a predetermined positional relationship with a virtual viewpoint accepted by the user input unit 201. The viewpoint corresponding to the second virtual viewpoint information is not limited to the virtual viewpoint, and may be a viewpoint of a specific camera among the imaging apparatuses 100.

Further, the second virtual viewpoint image management unit 208 outputs the second virtual viewpoint information to the virtual viewpoint image generation unit 203. The second virtual viewpoint image management unit 208 also holds a virtual viewpoint image input from the virtual viewpoint image generation unit 203, as the second virtual viewpoint image (other viewpoint image). The second virtual viewpoint image management unit 208 is assumed to manage only foreground images separately. Furthermore, to determine whether an object such as a player is included in the second virtual viewpoint image, the second virtual viewpoint image management unit 208 outputs the second virtual viewpoint image to the foreground image detection unit 207, and receives a result of detection processing about the presence or absence of the foreground image, from the foreground image detection unit 207. In addition, the second virtual viewpoint image management unit 208 outputs the foreground image of the second virtual viewpoint image to a foreground image placement unit 209, to change the position of the foreground image. Moreover, the second virtual viewpoint image management unit 208 outputs the foreground image of the second virtual viewpoint image to a foreground image display conversion unit 210, to add a special display effect to the foreground image of the second virtual viewpoint image.

The foreground image placement unit 209 decides a display position of the foreground image of the second virtual viewpoint image. The foreground image placement unit 209 of the present exemplary embodiment displays the foreground image of the second virtual viewpoint image, in a predetermined range from an edge of the first virtual viewpoint image. In addition, from a position of the second virtual viewpoint image relative to the first virtual viewpoint, the foreground image placement unit 209 determines in which direction the foreground image of the second virtual viewpoint image is positioned when viewed from the first virtual viewpoint. The foreground image placement unit 209 decides a position corresponding to the result of this determination, as the display position of the foreground image. In this way, using the difference (the comparison result) between the first virtual viewpoint information and the second virtual viewpoint information, the foreground image placement unit 209 of the present exemplary embodiment decides at which part on the first virtual viewpoint image the foreground image of the second virtual viewpoint image is to be displayed.

The foreground image display conversion unit 210 performs image processing for adding a display effect to the foreground image input from the second virtual viewpoint image management unit 208. The foreground image display conversion unit 210 then outputs the foreground image after the image processing to the second virtual viewpoint image management unit 208. The display effect is, for example, blinking display or semitransparent display of the foreground image.

A foreground image combining unit 211 generates a composite image in which the first virtual viewpoint image input from the first virtual viewpoint image management unit 202 and the foreground image input from the second virtual viewpoint image management unit 208 are superimposed on each other. The foreground image combining unit 211 then outputs the composite image to the image output unit 212. The foreground image combining unit 211 combines the foreground image of the second virtual viewpoint image at the predetermined position in the first virtual viewpoint image decided by the foreground image placement unit 209. In the present exemplary embodiment, there is mainly described an example of a case where combining processing performed by the foreground image combining unit 211 is processing for overwriting image data representing the predetermined region in the first virtual viewpoint image, with image data representing the foreground image of the second virtual viewpoint image. However, the combining processing is not limited to this example. For example, the first virtual viewpoint image, a foreground image of the second virtual viewpoint image, and position information indicating the display position of this foreground image may be transmitted from the image generation apparatus 200 to the terminal apparatus 300, and the combining processing may be performed in the terminal apparatus 300. In addition, in the present exemplary embodiment, an example in which the foreground image of the second virtual viewpoint image is displayed in the first virtual viewpoint image is mainly described, but this is not limitative. For example, the second virtual viewpoint image may be displayed in a region different from the display region of the first virtual viewpoint image. In this case, the foreground image combining unit 211 executes processing for outputting the position information that indicates the display position of the foreground image of the second virtual viewpoint image to be displayed together with the first virtual viewpoint image.

In other words, the foreground image combining unit 211 executes addition processing for displaying, together with the first virtual viewpoint image, information about a specific object (e.g., a player) detected from other viewpoint image (the second virtual viewpoint image) corresponding to other viewpoint different from the virtual viewpoint accepted by the user input unit 201. The information about the specific object may be an image of the specific object clipped from the second virtual viewpoint image (other viewpoint image), an icon or a graphic form representing the specific object, or a number representing the number of the specific objects. In a case where the specific object is a player, the uniform number of the player may be used as the information about the specific object.

The image output unit 212 has a function of converting an image into a transmission signal transmittable to the terminal apparatus 300, and outputting the transmission signal to the terminal apparatus 300. The image converted into the transmission signal is each of the first virtual viewpoint image input from the first virtual viewpoint image management unit 202 and the composite image input from the foreground image combining unit 211. The first virtual viewpoint image output from the image output unit 212 is displayed on a display of the terminal apparatus 300. In a case where a composite image is output from the image output unit 212, the composite image is displayed on the display of the terminal apparatus 300. The terminal apparatus 300 may be present as each of a plurality of terminal apparatuses. The terminal apparatus 300 used to designate a virtual viewpoint and the terminal apparatus 300 used to display a virtual viewpoint image may be different.

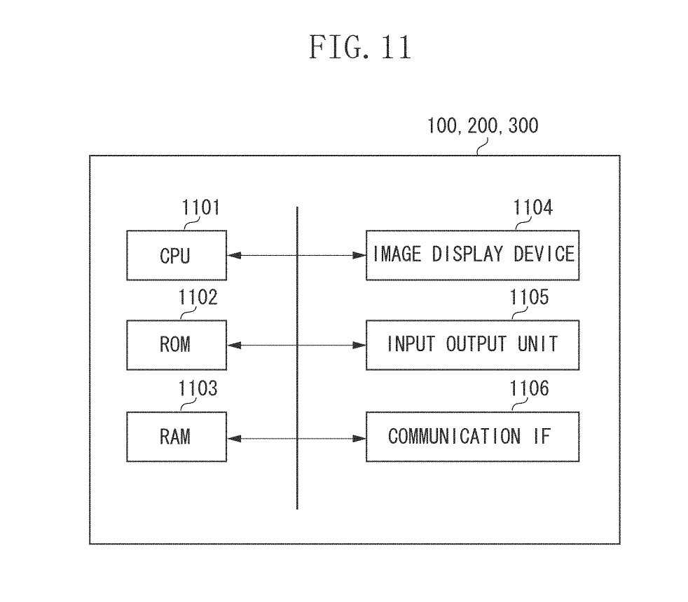

Next, a hardware configuration of each of the imaging apparatus 100, the image generation apparatus 200, and the terminal apparatus 300 in the present exemplary embodiment will be described with reference to FIG. 11.

The imaging apparatus 100, the image generation apparatus 200, and the terminal apparatus 300 each have a central processing unit (CPU) 1101, a read only memory (ROM) 1102, a random access memory (RAM) 1103, an image display device 1104, an input output unit 1105, a communication interface (IF) 1106, as illustrated in FIG. 11. In the imaging apparatus 100, the image generation apparatus 200, and the terminal apparatus 300 of the present exemplary embodiment, the CPU 1101 reads a program necessary for executing processing of the present exemplary embodiment and executes the read program, thereby implementing each processing to be described in the present exemplary embodiment.

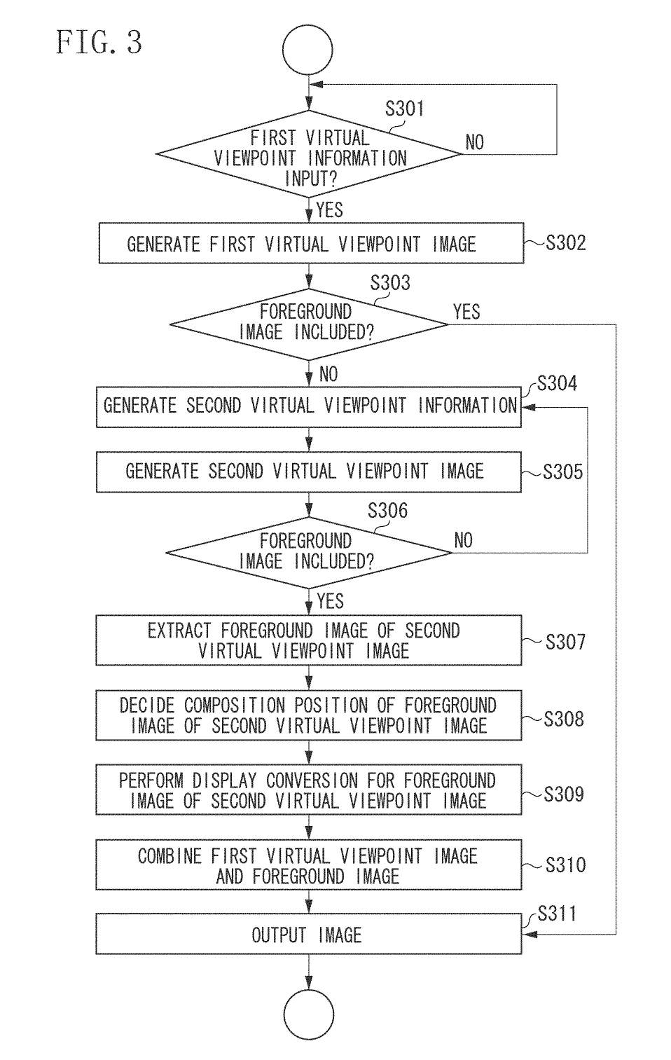

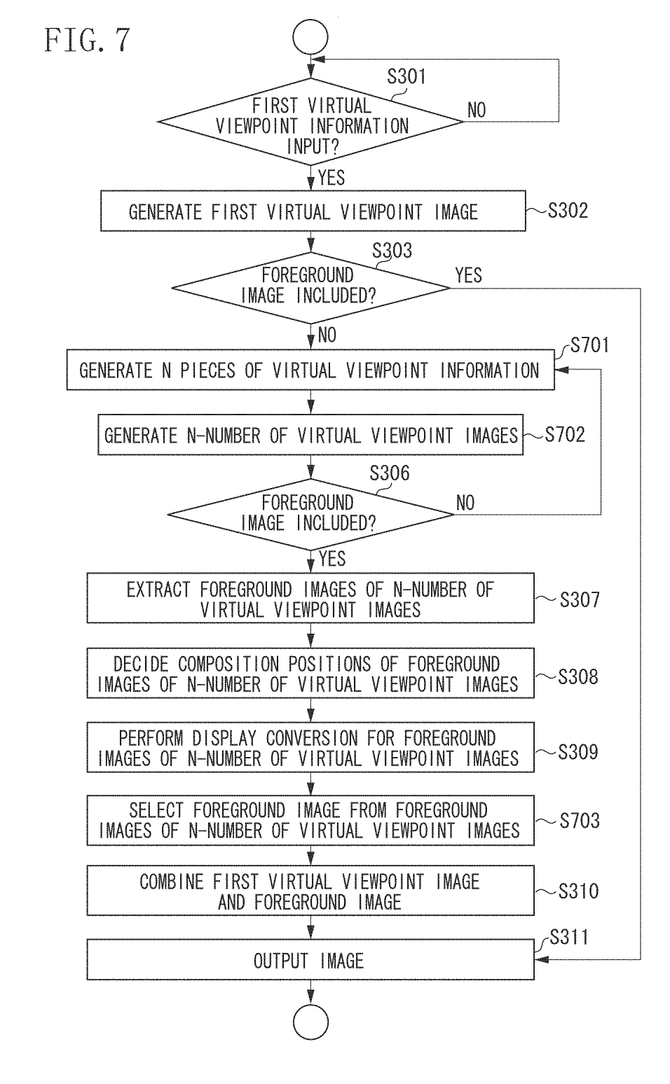

The processing implemented by the CPU 1101 of the imaging apparatus 100 includes imaging processing, and output processing for outputting a captured image to the image generation apparatus 200. The processing implemented by the CPU 1101 of the image generation apparatus 200 is described above with reference to FIG. 2. The processing executed by the CPU 1101 of the image generation apparatus 200 will be described in detail below with reference to a flowchart illustrated in each of FIG. 3 and FIG. 7. Further, the processing implemented by the CPU 1101 of the terminal apparatus 300 includes processing for accepting operation of setting a virtual viewpoint performed by the user, and display control processing for displaying a virtual viewpoint image corresponding to the set virtual viewpoint.

Each block illustrated in FIG. 11 is not limited to one. For example, the image generation apparatus 200 may have two or more CPUs 1101. In addition, each of the imaging apparatus 100, the image generation apparatus 200, and the terminal apparatus 300 does not necessarily have the entire hardware configuration illustrated in FIG. 11. For example, the image generation apparatus 200 may not have the image display device 1104. Further, the terminal apparatus 300 may not have the image display device 1104, and in this case, the terminal apparatus 300 and the image display device 1104 may be connected via a cable. The imaging apparatus 100 has an imaging unit including components such as a lens and an imaging device, in addition to the hardware configuration illustrated in FIG. 11.

The processing in each of the imaging apparatus 100, the image generation apparatus 200, and the terminal apparatus 300 may be partially implemented by exclusive hardware. Even if the processing is partially implemented by the exclusive hardware, the processing is still executed according to the control of the CPU 1101 (a processor).

Next, operation of the image generation apparatus 200 will be described. FIG. 3 is a flowchart illustrating the operation of the image generation apparatus 200 according to the first exemplary embodiment. An example to be described with reference to FIG. 3 is a case where, when an object (a specific object) is not detected from a virtual viewpoint image corresponding to a virtual viewpoint designated by a user, the object detected from other viewpoint image is combined with the virtual viewpoint image. The CPU 1101 of the image generation apparatus 200 reads a predetermined program and executes the read program, thereby implementing the processing in FIG. 3. The processing in FIG. 3 (e.g., processing for generating the first virtual viewpoint image and the second virtual viewpoint image) may be partially implemented by exclusive hardware, according to the control by the CPU 1101.

In step S301, the user input unit 201 converts a transmission signal from the terminal apparatus 300 into analyzable data, and thereby determines whether the first virtual viewpoint information is input. The first virtual viewpoint information is information about a virtual viewpoint designated by user operation performed on the terminal apparatus 300. The first virtual viewpoint information includes position information about the virtual viewpoint, and information about a viewpoint direction. In other words, the user input unit 201 accepts the virtual viewpoint designated for a virtual viewpoint image. If the user input unit 201 determines that the first virtual viewpoint information is not input (No in step S301), the user input unit 201 waits for an input. If the user input unit 201 determines that the first virtual viewpoint information is input (Yes in step S301), the processing proceeds to step S302. In step S302, the first virtual viewpoint image management unit 202 outputs the first virtual viewpoint information to the virtual viewpoint image generation unit 203, and the virtual viewpoint image generation unit 203 generates the first virtual viewpoint image. The generated first virtual viewpoint image is output to the foreground image detection unit 207, via the first virtual viewpoint image management unit 202.

In step S303, the foreground image detection unit 207 executes processing for detecting the foreground image (the specific object), for the first virtual viewpoint image generated by the virtual viewpoint image generation unit 203. In other words, the foreground image detection unit 207 determines whether the foreground image is included in the first virtual viewpoint image. If the foreground image detection unit 207 determines that the foreground image is included in the first virtual viewpoint image (Yes in step S303), the processing proceeds to step S311. In step S311, the foreground image detection unit 207 outputs the first virtual viewpoint image to the terminal apparatus 300, via the image output unit 212. The first virtual viewpoint image is a virtual viewpoint image corresponding to the virtual viewpoint designated by the user operation of the terminal apparatus 300.

In the present exemplary embodiment, the foreground image detection unit 207 determines whether the foreground image is included in the first virtual viewpoint image, by executing the processing for detecting the foreground image (the specific object), for the first virtual viewpoint image. However, this example is not limitative. For example, the processing for detecting the foreground image may be executed in an apparatus different from the image generation apparatus 200. In this case, the image generation apparatus 200 acquires the result of the processing for detecting the foreground image, from this different apparatus.

If the foreground image detection unit 207 determines that the foreground image is not included in the first virtual viewpoint image (No in step S303), the processing proceeds to step S304. In step S304, the second virtual viewpoint image management unit 208 generates the second virtual viewpoint information representing the second virtual viewpoint having a predetermined positional relationship with the first virtual viewpoint. For example, a viewpoint at a position behind the first virtual viewpoint and 10 m away therefrom is the second virtual viewpoint information.

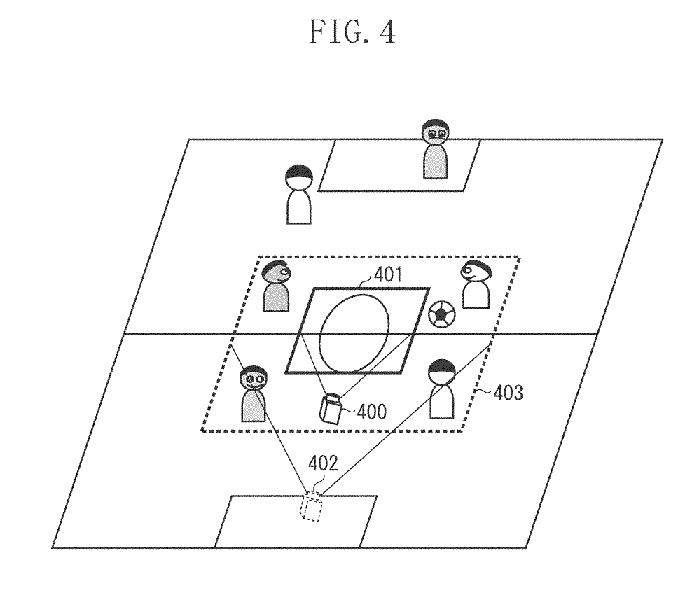

FIG. 4 is a conceptual diagram illustrating the first virtual viewpoint and the second virtual viewpoint, as well as a range of the virtual viewpoint image corresponding to each of these viewpoints. A first virtual viewpoint 400 corresponds to a camera indicated with a solid line, and the first virtual viewpoint image corresponding to the first virtual viewpoint 400 corresponds to a range 401. Further, a second virtual viewpoint 402 corresponds to a camera indicated with a dotted line, and the second virtual viewpoint image corresponding to the second virtual viewpoint 402 corresponds to a range 403. In FIG. 4, no object appears in the first virtual viewpoint image, but four objects appear in the second virtual viewpoint image.

In step S305, the second virtual viewpoint image management unit 208 outputs the second virtual viewpoint information generated in step S304 to the virtual viewpoint image generation unit 203, and the virtual viewpoint image generation unit 203 generates the second virtual viewpoint image corresponding to the second virtual viewpoint information.

In step S306, the foreground image detection unit 207 receives the second virtual viewpoint image generated by the virtual viewpoint image generation unit 203 from the second virtual viewpoint image management unit 208, and thereby determines whether the foreground image (the specific object) is included in the second virtual viewpoint image.

If the foreground image detection unit 207 determines that the foreground image is not included in the second virtual viewpoint image (other viewpoint image) (No in step S306), the processing proceeds to step S304. In step S304, the second virtual viewpoint image management unit 208 generates other piece of second virtual viewpoint information. In step S305, the virtual viewpoint image generation unit 203 generates the second virtual viewpoint image corresponding to the other second virtual viewpoint information generated in step S304 for the second time. Subsequently, in step S306, the foreground image detection unit 207 determines whether the object (the specific object) is detected from this second virtual viewpoint image. Step S304 to step S306 may be repeated until the foreground image detection unit 207 determines that the foreground image is included in the second virtual viewpoint image. In a case where no object is detected even if step S304 to step S306 are repeated a predetermined number of times, it may be decided not to perform the combining processing (the addition processing) for the foreground image and then, the processing may proceed to the next step. Further, in a case where it is decided not to perform the combining processing for the foreground image because no object is detected even if step S304 to step S306 are repeated a predetermined number of times, a notification of this detection result may be displayed on the display of the terminal apparatus 300.

If the foreground image detection unit 207 determines that the foreground image is included in the second virtual viewpoint image (Yes in step S306), the processing proceeds to step S307. In step S307, the second virtual viewpoint image management unit 208 clips the foreground image from the second virtual viewpoint image.

Subsequently, in step S308, the foreground image placement unit 209 decides a composition position of the foreground image of the second virtual viewpoint image, based on the positional relationship between the first virtual viewpoint and the second virtual viewpoint, as well as the position of the object detected from the second virtual viewpoint image.

Next, in step S309, the foreground image display conversion unit 210 performs display conversion processing for the foreground image to be combined with the first virtual viewpoint image. The display conversion processing is, for example, processing for conversion into blinking display or semitransparent display of the foreground image. The user can recognize that the foreground image of the second virtual viewpoint image is an object that is not present in the first virtual viewpoint image, by performing such display conversion processing.

In step S310, the foreground image combining unit 211 generates a composite image, by combining the first virtual viewpoint image input from the first virtual viewpoint image management unit 202, and the foreground image input from the second virtual viewpoint image management unit 208. In other words, the foreground image combining unit 211 executes the addition processing for displaying, together with the virtual viewpoint image, the information about the specific object detected from the other viewpoint image corresponding to the other viewpoint different from the virtual viewpoint according to the user operation. This addition processing may be processing for combining the foreground image of the second virtual viewpoint image with the first virtual viewpoint image. Alternatively, the addition processing may be processing for generating an instruction for displaying the foreground image of the second virtual viewpoint image in a region different from the display region of the first virtual viewpoint image. Next, in step S311, the image output unit 212 outputs the composite image generated by the foreground image combining unit 211, to the terminal apparatus 300.

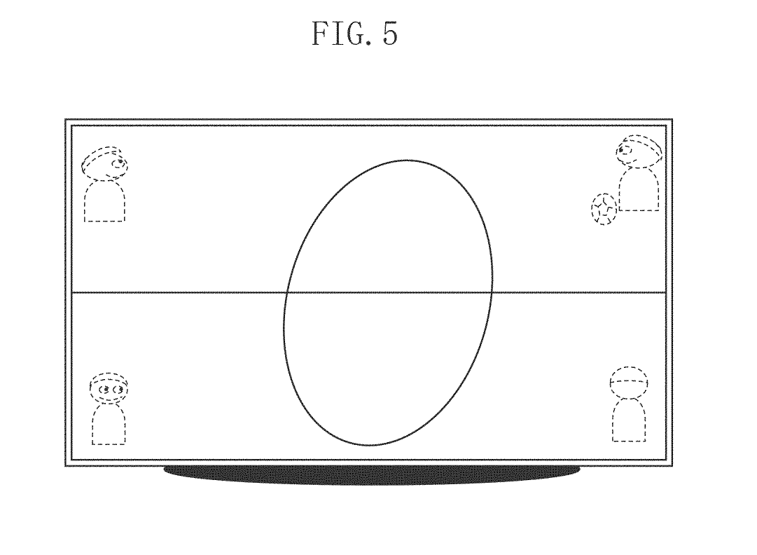

FIG. 5 is an example of a screen of the terminal apparatus 300. FIG. 5 illustrates a composite image in which the object detected from the second virtual viewpoint image is made semitransparent and combined with the first virtual viewpoint image, in a case where no object appears in the first virtual viewpoint image. In FIG. 5, each object indicated with a dotted line is in a semitransparent state.

This combined object is semitransparent and thus can be recognized as an object not appearing in the first virtual viewpoint image. In addition, the orientation and the shape of the body of this combined object are displayed in an as-is state. Therefore, the user can recognize the status of the object in a simple and intuitive manner. Accordingly, the user can move the virtual viewpoint toward a desired object, without performing complicated user operation.

As described above, according to the first exemplary embodiment, in a case where no object is detected from the virtual viewpoint image corresponding to the virtual viewpoint designated by the user operation, the information of the object detected from the other virtual viewpoint image, which corresponds to the other viewpoint different from the virtual viewpoint, is combined with the virtual viewpoint image. The image resulting therefrom is displayed. Such a configuration can reduce time and effort, as compared with looking for an object by performing viewpoint-moving operation. Therefore, operability related to setting of a virtual viewpoint can be improved.

A second exemplary embodiment will be described focusing on difference from the first exemplary embodiment. An example to be mainly described in the second exemplary embodiment is as follows. First, an object (a specific object) is detected from a plurality of second virtual viewpoint images corresponding to a plurality of second virtual viewpoints. When a plurality of objects is detected, information about an object selected from the detected objects is combined with a first virtual viewpoint image, and thereby a composite image is generated.

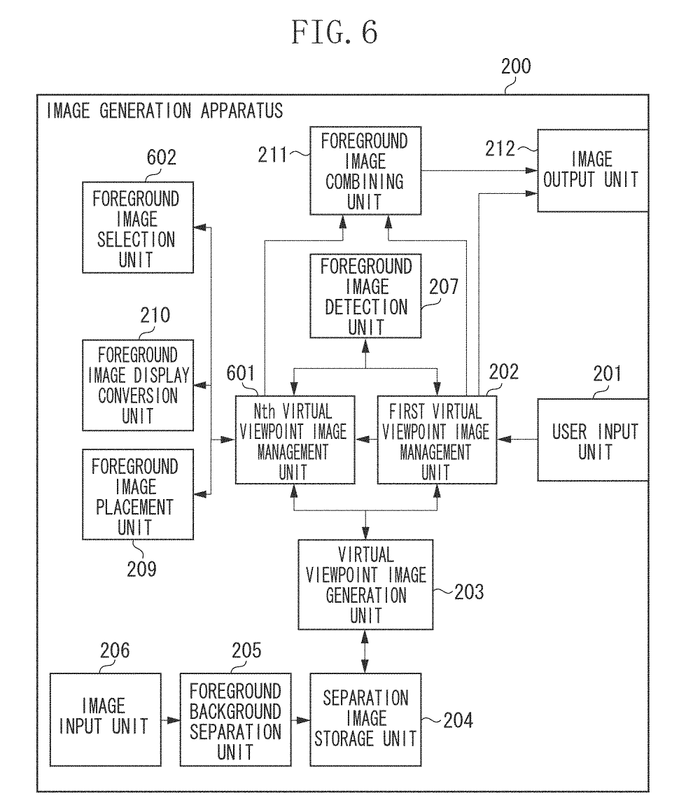

FIG. 6 is a functional block diagram of an image generation apparatus 200 according to the second exemplary embodiment. Difference from FIG. 2 will be mainly described in detail with reference to FIG. 6.

An Nth virtual viewpoint image management unit 601 converts first virtual viewpoint information input from a first virtual viewpoint image management unit 202, thereby generating N (N is an integer of 2 or greater) pieces of viewpoint information. For example, the Nth virtual viewpoint image management unit 601 generates information about a viewpoint located behind a first virtual viewpoint, or viewpoint information located in a lateral direction of the first virtual viewpoint. In addition, not only making a change in a viewpoint position, but also making a change in a viewpoint direction is allowed. Moreover, the Nth virtual viewpoint image management unit 601 outputs a plurality of pieces of virtual viewpoint information to a virtual viewpoint image generation unit 203. The Nth virtual viewpoint image management unit 601 also holds a plurality of virtual viewpoint images input from the virtual viewpoint image generation unit 203, as Nth virtual viewpoint images. Functions except for this function are similar to those of a second virtual viewpoint image management unit 208.

A foreground image selection unit 602 determines which one of foreground images input from the Nth virtual viewpoint image management unit 601 is to be combined with a first virtual viewpoint image. For example, in a case where a soccer game is imaged, a foreground image can be set beforehand. Examples of the foreground image include a foreground image corresponding to each player in a team supported by a user between two teams, a foreground image corresponding to a notable player, and a foreground image corresponding to a player near a ball. In this case, the foreground image selection unit 602 can decide a foreground image to be combined with the first virtual viewpoint image from among a plurality of foreground images, based on the above-described setting.

Next, operation of the image generation apparatus 200 will be described. FIG. 7 is a flowchart illustrating the operation of the image generation apparatus 200 according to the second exemplary embodiment. Assume that, in a case where no object is detected from the first virtual viewpoint image, only an object, which is selected from objects detected from other virtual viewpoint images corresponding to other viewpoints, is to be combined with the first virtual viewpoint image. This case will be mainly described as an example, with reference to FIG. 7. In the present exemplary embodiment, difference from FIG. 3 will be mainly described with reference to FIG. 7.

In step S701, the Nth virtual viewpoint image management unit 601 generates N pieces of virtual viewpoint information by converting the first virtual viewpoint information. For example, a viewpoint (first other viewpoint) at a position behind the first virtual viewpoint and 10 m away therefrom is assumed to be second virtual viewpoint information. Further, a viewpoint (second other viewpoint) at a position on the left of the first virtual viewpoint and 10 m away therefrom is assumed to be third virtual viewpoint information. Subsequently, in step S702, the virtual viewpoint image generation unit 203 generates an N-number of virtual viewpoint images corresponding to the N pieces of virtual viewpoint information.

Further, in step S703, the foreground image selection unit 602 selects (decides) a foreground image to be combined with the first virtual viewpoint image, from foreground images of the N-number of virtual viewpoint images. Here, assume that, only each player of a team, which is supported by the user between two teams playing a soccer game, is selected as the foreground image to be combined with the first virtual viewpoint image.

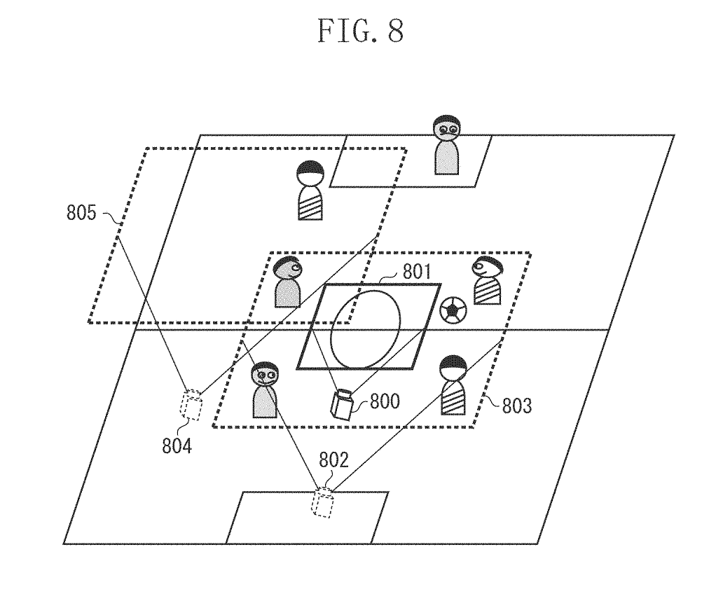

FIG. 8 is a conceptual diagram illustrating the first virtual viewpoint and the other virtual viewpoints, as well as a range of a view from each of these viewpoints. A first virtual viewpoint 800 corresponds to a camera indicated with a solid line, and a first virtual viewpoint image corresponding to the first virtual viewpoint 800 corresponds to a range 801. Further, an N-number of virtual viewpoints, which are a second virtual viewpoint 802 and a third virtual viewpoint 804, correspond to two cameras each indicated with a dotted line. A second virtual viewpoint image (first other viewpoint image) corresponding to the second virtual viewpoint 802 corresponds to a range 803, and a third virtual viewpoint image (second other viewpoint image) corresponding to the third virtual viewpoint 804 corresponds to a range 805. In a state illustrated in FIG. 8, no object appears in the range 801 (the first virtual viewpoint image). However, four objects appear in the range 803 (the second virtual viewpoint image), and two objects appear in the range 805 (the third virtual viewpoint image). In FIG. 8, people indicated with hatched lines are players in a first team, and people filled with black are players in a second team.

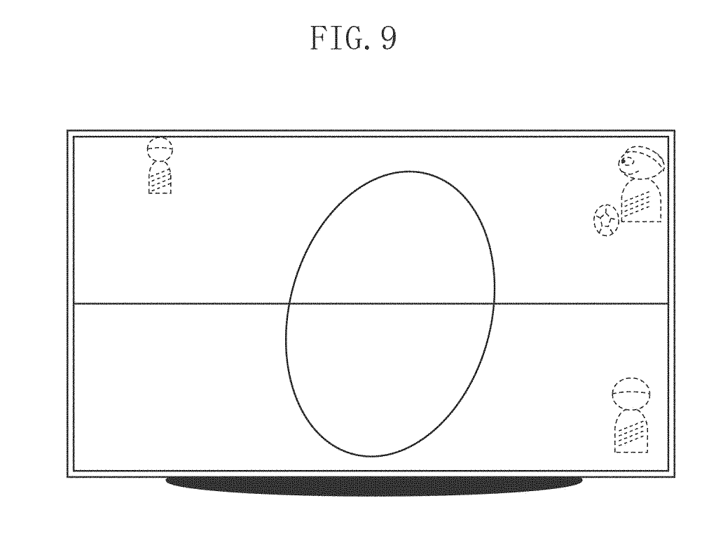

FIG. 9 is an example of a screen of a terminal apparatus 300. In a case where no object appears in the first virtual viewpoint image, the terminal apparatus 300 displays a composite image, in which only foreground images corresponding to people indicated with hatched lines, among objects detected from the virtual viewpoint images of the N-number of the other viewpoints, are combined with the first virtual viewpoint image. In this way, in a case where a plurality of objects (specific objects) is present, the objects are narrowed down to an object to be combined with the first virtual viewpoint image, based on user setting. Thanks to such a configuration, the user can more easily and intuitively recognize the status of an object to be displayed. Therefore, the user can move the virtual viewpoint toward a player supported (to be focused on) by the user, while performing less complicated user operation.

As described above, according to the second exemplary embodiment, in a case where no object is detected from a virtual viewpoint image corresponding to a virtual viewpoint designated by user operation, information about an object, which is detected from each of other virtual viewpoint images corresponding to viewpoints different from this virtual viewpoint, is combined with the virtual viewpoint image. Such a configuration can reduce time and effort, as compared with looking for an object by performing viewpoint-moving operation. Therefore, operability related to setting of a virtual viewpoint can be improved.

### Other Exemplary Embodiments

In the above-described exemplary embodiments, there is mainly described the example of the case where the user performs operation for moving of the virtual viewpoint while viewing the composite image. However, this example is not limitative. For example, the user may control a virtual viewpoint to place an object in the first virtual viewpoint image, by designating the object to be tracked, among objects displayed on a composite image.

Further, in the above-described exemplary embodiments, there is mainly described the example of the case where the foreground image of the second virtual viewpoint image is combined with the first virtual viewpoint image. However, instead of the foreground image, a simple graphic form, an icon, or a number indicating a specific object may be combined.

Furthermore, in the above-described exemplary embodiments, there is mainly described the example of the case where the foreground image of the second virtual viewpoint image is combined with the first virtual viewpoint image. However, instead of being combined, the foreground image may be displayed in a region different from the display region of the first virtual viewpoint image.

Still furthermore, in the above-described exemplary embodiments, there is mainly described the example of the case where the view point having a predetermined positional relationship with the first virtual viewpoint is the second virtual viewpoint, but this example is not limitative. For example, the second virtual viewpoint may be set to keep tracking an object such as a specific player or ball.

Moreover, in the above-described exemplary embodiments, there is mainly described the example of the case where, when no object (specific object) is detected from the first virtual viewpoint image, the second virtual viewpoint image of other viewpoint is generated, and the operation for detecting the object from the second virtual viewpoint image is performed. However, this example is not limitative. For example, the processing (step S304 to step S310 in FIG. 3) including the generation of the second virtual viewpoint image may be executed, in a case where only a predetermined number or less of objects are detected from the first virtual viewpoint image. Alternatively, for example, the processing (step S304 to step S310 in FIG. 3) including the generation of the second virtual viewpoint image may be executed, in a case where none of players in a specific team is detected from the first virtual viewpoint image. Still alternatively, for example, the processing in step S304 to step S310 in FIG. 3 may be executed regardless of whether an object is detected from the first virtual viewpoint image.

In the above-described exemplary embodiments, the configurations and functions of the image generation apparatus 200 are described in detail mainly with reference to FIGS. 2, 3, 6, and 7. However, these configurations and functions may be partially executed by the imaging apparatus 100 and the terminal apparatus 300. For example, the terminal apparatus 300 may accept a virtual viewpoint designated by the user, and may acquire a detection processing result indicating whether an object (specific object) is detected from a virtual viewpoint image corresponding to this virtual viewpoint. In this case, the terminal apparatus 300 can combine a foreground image of the second virtual viewpoint image with the first virtual viewpoint image according to the acquired detection processing result, and display a resultant image. Each of the apparatuses according to the present exemplary embodiments can thus adopt various modifications.

An exemplary embodiment of the present disclosure can also be implemented by such processing that a program that implements one or more functions of the above-described exemplary embodiments is supplied to a system or an apparatus via a network or a storage medium. One or more processors in a computer of the system or the apparatus read the program and then execute the read program. Moreover, an exemplary embodiment of the present disclosure can also be implemented by a circuit (e.g., an application-specific integrated circuit (ASIC)) that implements one or more functions.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-188762, filed Sep. 27, 2016, which is hereby incorporated by reference herein in its entirety.

What is claimed is:

1. An image processing apparatus comprising:
an accepting unit configured to accept a virtual viewpoint designated for a virtual viewpoint image to be generated based on images captured by each of a plurality of cameras for capturing an object from a plurality of different directions;
an acquisition unit configured to acquire a result of specific-object detection processing performed for a virtual viewpoint image corresponding to the virtual viewpoint accepted by the accepting unit; and
an addition unit configured to execute addition processing for displaying, together with the virtual viewpoint image corresponding to the virtual viewpoint accepted by the accepting unit, information about a specific object detected from another viewpoint image corresponding to another viewpoint different from the virtual viewpoint accepted by the accepting unit, the addition processing being executed according to the result acquired by the acquisition unit, of the specific-object detection processing performed for the virtual viewpoint image.

2. The image processing apparatus according to claim 1, wherein the another viewpoint is a virtual viewpoint having a predetermined positional relationship with the virtual viewpoint accepted by the accepting unit.

3. The image processing apparatus according to claim 1, wherein the addition unit executes the addition processing, in a case where the acquisition unit acquires a detection processing result indicating that a number of specific objects, which are detected from the virtual viewpoint image, is less than a predetermined number.

4. The image processing apparatus according to claim 1, further comprising a decision unit configured decide a position, to which the information about the specific object is to be added by the addition processing, on the virtual viewpoint image, based on a positional relationship between the virtual viewpoint accepted by the accepting unit and the another viewpoint, and a position of the specific object in the another viewpoint image.

5. The image processing apparatus according to claim 1, wherein the addition unit executes the addition processing to display the information about the specific object, in a display region different from a display region of the virtual viewpoint image.

6. The image processing apparatus according to claim 1, further comprising a detection unit configured to detect the specific object from the virtual viewpoint image,
wherein the acquisition unit acquires a result of detection processing performed by the detection unit.

7. The image processing apparatus according to claim 1, wherein, in a case where the specific object is not detected from the another viewpoint image, the addition unit executes addition processing for adding information about the specific object detected from a second other viewpoint image corresponding to a second other viewpoint different from the another viewpoint, to the virtual viewpoint image.

8. The image processing apparatus according to claim 7, wherein, in a case where the specific object is not detected from the another viewpoint image and the second other viewpoint image, the addition unit does not add the information about the specific object to the virtual viewpoint image.

9. The image processing apparatus according to claim 7, further comprising a display control unit configured to display, in a case where the specific object is not detected from the another viewpoint image and the second other viewpoint image, a notification of a detection result thereof, on a display.

10. The image processing apparatus according to claim 1, further comprising a selection unit configured to select, in a case where the specific object is detected from each of a plurality of other viewpoint images corresponding to a plurality of other viewpoints different from the virtual viewpoint accepted by the accepting unit, which one of the plurality of other viewpoint images is to be used to display information about the detected specific object,
wherein the addition unit executes addition processing such that the information about the specific object selected by the selection unit is displayed together with the virtual viewpoint image.

11. The image processing apparatus according to claim 1, wherein the specific object includes at least one of a person corresponding to a predetermined image pattern, a person to be detected from a predetermined space region, and a ball.

12. The image processing apparatus according to claim 1, further comprising a display unit configured to display the virtual viewpoint image for which the addition processing performed by the addition unit is completed.

13. The image processing apparatus according to claim 1, wherein the information about the specific object to be added by the addition unit includes at least one of an image of the specific object clipped from the other viewpoint image, a graphic form indicating the specific object, an icon indicating the specific object, and a number indicating a number of specific objects each corresponding to the specific object.

14. An image processing method, comprising:
accepting a virtual viewpoint designated for a virtual viewpoint image to be generated based on images captured by each of a plurality of cameras for capturing an object from a plurality of different directions;
acquiring a result of specific-object detection processing performed for a virtual viewpoint image corresponding to the virtual viewpoint; and
executing addition processing for displaying, together with the virtual viewpoint image corresponding to the virtual viewpoint, information about a specific object detected from another viewpoint image corresponding to another viewpoint different from the virtual viewpoint, the addition processing being executed according to the result of the specific-object detection processing performed for the virtual viewpoint image.

15. A computer readable storage medium storing instructions that, when executed, cause a computer to execute an image processing process, the image processing process comprising:
accepting a virtual viewpoint designated for a virtual viewpoint image to be generated based on images captured by each of a plurality of cameras for capturing an object from a plurality of different directions;
acquiring a result of specific-object detection processing performed for a virtual viewpoint image corresponding to the virtual viewpoint; and
executing addition processing for displaying, together with the virtual viewpoint image corresponding to the virtual viewpoint, information about a specific object detected from another viewpoint image corresponding to another viewpoint different from the virtual viewpoint, the addition processing being executed according to the result of the specific-object detection processing performed for the virtual viewpoint image.

16. A display method comprising:
acquiring a virtual viewpoint for a virtual viewpoint image to be generated based on images captured by each of a plurality of cameras for capturing an object from a plurality of different directions; and
causing a display unit to display the virtual viewpoint image corresponding to the acquired virtual viewpoint, and information about a specific object present outside a viewing angle of the virtual viewpoint image.

17. The display method according to claim 16, wherein the specific object includes at least one of a person corresponding to a predetermined image pattern, a person to be detected from a predetermined space region, and a ball.

18. The display method according to claim 16, wherein the display unit displays the virtual viewpoint image and the information about the specific object superimposed on each other.

19. The display method according to claim 16, wherein the display unit displays the virtual viewpoint image and the information about the specific object, in a manner that allows an object appearing in the virtual viewpoint image and the information about the specific object to be distinguished from each other.
